(19) United States
(12) Patent Application Publication
(10) Pub. No.: US 2007/0267289 A1
(43) Pub. Date: Nov. 22, 2007

(54) HYDROGEN PRODUCTION USING PLASMA- BASED REFORMATION

(76) Inventors: Harry Jabs, Stafford, TX (US); Daniel Westerheim, College Station, TX (US); Brian Hennings, College Station, TX (US); Daniel Soekamto, Houston, TX (US); Surya Shandy, College Station, TX (US); Zoran Minevski, The Woodlands, TX (US); Alan J. Cisar, Cypress, TX (US)

Correspondence Address: STREETS & STEELE, 13831 NORTHWEST FREEWAY, SUITE 355, HOUSTON, TX, 77040, US

(21) Appl. No.: 11/696,354

(22) Filed: Apr. 4, 2007

Related U.S. Application Data
(60) Provisional application No. 60/744,352, filed on Apr. 6, 2006.

(51) Int. Cl. B01J 12/00

(52) U.S. Cl. 204/170

(57) ABSTRACT

Hydrogen gas production includes supplying a hydrocarbon fluid to a gap between a pair of electrodes, applying a voltage across the electrodes to induce an electrical arc, wherein the electrical arc contacts the hydrocarbon to form a plasma and produces a gaseous product comprising hydrogen gas and a solid product comprising carbon, and dynamically adjusting the gap length to control at least one parameter of the plasma. Preferably, the gap length is decreased during plasma initiation or reformation and increased to increase the hydrogen gas production rate. The method preferably includes dynamically adjusting the spatial separation of the electrodes and rotating at least one electrode while generating hydrogen gas to reduce adherence of solids to the electrodes. Furthermore, the polarity of the electrodes may be periodically reversed, primarily to reduce adherence of solids. If the hydrocarbon fluid is a liquid, the method may include controlling the level of the hydrocarbon liquid relative to the pair of electrodes.

This application claims priority of U.S. provisional patent application 60/744,352 filed on Apr. 6, 2006.

This invention was made with government support under contract numbers F09650-02-M-0523, F09650-03-C-0036, FA8501-05-M-0163 awarded by the United States Air Force, under contract number DE-FG02-05ER84240 awarded by Department of Energy (DOE) and under contract numbers NNG05CA63C and NNC06CA35C awarded by the National Aeronautics and Space Administration (NASA). The government has certain rights in this invention.

### BACKGROUND OF THE INVENTION

1. Field of the Invention

This invention relates to plasma systems and more specifically, to methods and apparatus for plasma reforming of hydrocarbons to produce hydrogen and carbon.

2. Description of the Related Art

The use of a plasma to crack or reform hydrocarbons has been demonstrated for well over 60 years and reported, for example, in U.S. Pat. No. 2,018,161 issued to Weber, et al., U.S. Pat. No. 2,263,443 issued to Matheson, U.S. Pat. No. 6,395,197 issued to Detering, et al. and in the U.S. Patent Application Publication No. 2003/0143445 of Daniel, et al.

Weber disclosed a system for hydrogenating a hydrocarbon using a pair of electrodes, one of which consisted of a catalytic material, immersed in the hydrocarbon liquid. The system included means for passing a high frequency current between the pair of electrodes. The catalytic material was subsequently dispersed within the liquid hydrocarbon, wherein it interacted with hydrogen introduced from an external source to aid in the hydrogenation and cracking of the hydrocarbon.

Matheson described an apparatus used for the pyrolysis of liquid hydrocarbons to produce acetylene. Matheson disclosed that an increase in operating efficiency could be obtained by rotating one or more of the electrodes. The disclosed device included electrodes protruding perpendicular to the axis of a rotating shaft that was synchronously rotated with the oscillations of the potential. The rotation and geometry of the electrodes provided that the potential was at a maximum when the electrode distance was at a maximum and the voltage was exactly the breakdown voltage when the gap was at a minimum. However, such rotation requires the plasma to be extinguished and reignited at least once per revolution per electrode, thereby requiring additional energy to breakdown and ionize the liquid between the electrodes for each reignition. This system operated on potentials ranging from 500-10,000 VAC.

Detering, et al., disclosed a rapid quench reactor for producing hydrogen and carbon. The rapid quench reactor included a plasma torch positioned adjacent to the reactor chamber. The torch was used to thermally decompose an incoming stream injected into the plasma formed by the plasma torch. Detering disclosed that many plasma gases are suitable for use in the plasma torch, but a preferred plasma gas is hydrogen. After introducing the reactants into the plasma, a convergent/divergent nozzle rapidly cools the exiting reactor gases. During the fast quench, the unsaturated hydrocarbons are further decomposed by reheating the reactor gases. The disclosed system operates on voltages from 100 to 500 VDC.

Daniel et al., developed a plasma reformer that reforms hydrocarbon fuels in an oxygen rich atmosphere (e.g., air) utilizing a cooled reactor chamber. Daniel disclosed a plasma-generating assembly having two electrodes spaced apart one from another so as to define an electrode gap. A plasma arc forms within this gap when an electrical current is supplied to one of the electrodes. A hydrocarbon fuel is then injected through a nozzle into the plasma arc. Pressurized air is directed radially inward through the electrode gap so as to “bend” the plasma arc inward. Such bending of the plasma arc attempts to ensure that the fuel injected through the nozzle contacts the plasma arc. The resulting reformate gas product is rich in hydrogen and carbon monoxide. The gas further is disclosed as containing soot that may be filtered out by passing the reformate gas through a soot filter.

The majority of existing plasma fuel reformation processes are performed aerobically; that is, in the presence of oxygen. Plasma reformation that occurs in an oxygen environment produces a reformate stream that is rich in oxidized compounds, e.g., CO, CO₂, SOₓ and H₂O, which reduces the reformate quality by diluting the hydrogen content of the reformate stream with undesirable gases. Furthermore, if the reformation is carried out in air, not only are the oxygen diluents formed, but nitrogen containing diluents, e.g., NOₓ, are also formed, which are also environmentally harmful compounds.

Lynum, et al. have a number of patents that include, for example, U.S. Pat. Nos. 5,481,080, 5,989,512, 5,997,837 and 6,068,827, that concern pyrolitic decomposition of hydrocarbons for the production of solid carbon black and hydrogen. As is the case for most of the reformate processes, the disclosed methods and systems include a plasma torch operating in a gaseous environment with reactant feed being introduced into the formed plasma. Lynum further disclosed that introducing additional reactants into the reactor chamber to mix with the products from the plasma torch can influence the mix and quality of the final product.

In U.S. Pat. No. 5,626,726, Kong disclosed a method for cracking a liquid hydrocarbon composition to produce a cracked hydrocarbon product. The disclosed method includes generating an electrical arc between two electrodes that are entirely submerged in the composition and then delivering a reactive gas to the arc that forms a bubble around the arc. The required reactive gas that is used to form the bubble is disclosed as being delivered either through passages that are within the electrodes themselves or though separate delivery conduits. The minimum voltage requirement for the disclosed apparatus and method is 500 V, with an optimum range disclosed as being between about 900-1500 V DC or AC.

In U.S. Pat. No. 6,926,872, Santilli disclosed apparatus and methods for processing crude oil, oil based liquid wastes or water based liquid wastes into a clean burning combustible gas via a submerged electrical arc between at least one pair of consumable electrodes. The electrodes are disclosed to be made of a carbon-based material that is consumed during the reaction to form CO and hydrogen. Santilli sought to resolve the limitation he found in the prior art—that the prior art was unable to produce a clean burning combustible gas when using oil as a feedstock because of the lack of oxygen in the oil. Therefore, Santilli disclosed circulating a liquid additive through the submerged electric arc that is rich in a substance missing in the liquid feedstock, such as circulating water as an oxygen-rich stream through the submerged arc. Because Santilli uses consumable electrodes, Santilli further disclosed a mechanism for moving the electrodes together to maintain the gap between the electrodes as the electrodes are consumed in the process.

In spite of the vast amount of work that has been accomplished in the field of plasma reforming to form hydrogen and carbon from a hydrocarbon feedstock, there is still a need to find improved apparatus and methods for efficiently producing a high purity stream of hydrogen. Preferably, the apparatus and method would also produce a useable carbon product.

### SUMMARY OF THE INVENTION

The present invention provides a method for producing hydrogen gas. The method comprises supplying fluid hydrocarbons to a gap between a pair of electrodes, applying a voltage across the pair of electrodes to induce an electrical arc in the gap, wherein the electrical arc contacts the hydrocarbons to form a plasma and produce hydrogen gas and a solid product comprising carbon, and dynamically adjusting the gap length or distance to control at least one parameter of the plasma. Preferably, the gap length is decreased during initiation or reformation of the plasma and increased to increase the rate of hydrogen gas production. The pair of electrodes is preferably dynamically adjustable over a gap length ranging between about 1 mm and about 20 mm. In an optional mode of operation, a constant electrical current flow is maintained between the pair of electrodes, and the gap length is increased in order to increase the voltage potential between the pair of electrodes, resulting in an increase of the plasma size and an increase of the hydrogen gas production rate. In an optional alternative mode of operation, a constant voltage is maintained between the pair of electrodes, and the gap length is increased to decrease electrical current flow between the pair of electrodes, resulting in a decrease of the plasma size and a decrease of the hydrogen gas production rate.

The method preferably includes rotating at least one of the electrodes during the step of generating hydrogen gas. The rotation of the at least one of the electrodes has been found to reduce adherence of the solid product to the pair of electrodes. Desirably, rotation of the at least one of the electrodes does not change the gap length. In this manner, the gap length and the rotation can be independently controlled. The method optionally comprises rotating at least the negative polarity electrode during the step of generating hydrogen gas. In a further option, the polarity of the electrodes is periodically reversed, primarily to reduce adherence of a solid product to the pair of electrodes.

In one embodiment, the hydrocarbon fluid is a liquid. Preferably, this embodiment includes controlling the level of the hydrocarbon liquid relative to the pair of electrodes. In one optional configuration, the pair of electrodes are generally horizontally spaced, and the hydrocarbon liquid level only partially submerges each of the electrodes. In another optional configuration, the pair of electrodes are generally vertically spaced, and the hydrocarbon liquid level submerges one electrode and does not submerge another electrode. Although these optional configurations are preferred, it is possible to have both electrodes fully immersed in the hydrocarbon, only one electrode fully immersed in the hydrocarbon, or neither electrode fully immersed in the hydrocarbon. Specifically, it is possible to have at least one of the electrodes fully above the level of the hydrocarbon liquid.

The method may be carried out at various voltages across the electrodes, such as in a range between about 1 V and about 50 kV, preferably between about 5 V and about 1000 V, more preferably between about 10 V and about 200 V, and most preferably between about 30 V and about 50 V. Suitably, the current flow between the electrodes ranges between about 5 mA and about 150 A, preferably between about 10 mA and about 120 A, and most preferably between about 20 A and about 100 A.

It is preferred to provide an essentially anaerobic atmosphere, such as a nitrogen atmosphere, over the hydrocarbon liquid. It may also be beneficial to remove dissolved or entrained oxygen from the hydrocarbon liquid prior to supplying the hydrocarbon liquid into the gap. Preferably, the hydrocarbon liquid supplied to the pair of electrodes is circulated.

Furthermore, the products of the process can be managed in various beneficial ways. In one embodiment, the liquid hydrocarbon is circulated through a solids separation device, and at least a portion of the solid carbon product suspended in the circulating liquid hydrocarbon is separated out. In a further embodiment, the flow of hydrogen gas out of a chamber surrounding the pair of electrodes is controlled to obtain a desired pressure within the chamber.

In another embodiment, the hydrocarbon fluid is a gas. The gas flows into the electrode chamber where the gas is exposed to the plasma, preferably in an anaerobic or substantially oxygen-free atmosphere. Most preferably, the electrode chamber is purged and filled with the gaseous hydrocarbon. Carbon can be removed from the gaseous product stream using electrostatics or other separation techniques. The hydrogen product can be separated from the gaseous feedstock by purification membranes, absorptive beds, or other established separation technologies.

In a still further embodiment, at least one chemical compound may be added into the hydrocarbon fluid to increase production of a desired solid product. For example, metal-containing compounds such as metal-containing inorganic or organic salts or organometallic compounds, can be added into the hydrocarbon fluids to produce carbon-supported metals or alloys. In particular, platinum acetylacetonate may be added to a hydrocarbon liquid so that the plasma produces a solid product that includes carbon-supported platinum that is suitable as a catalyst.

The foregoing and other objects, features and advantages of the invention will be apparent from the following more particular description of a preferred embodiment of the invention, as illustrated in the accompanying drawing wherein like reference numbers represent like parts of the invention.

### BRIEF DESCRIPTION OF THE DRAWINGS

FIGS. 1A-J are side views of pairs of electrodes arranged in a variety of exemplary arrangements and are capable of a variety of movements for use in a plasma reformer in accordance with the present invention.

FIGS. 2A-J are perspective views of exemplary electrode tips that are suitable for use in a plasma reformer.

FIG. 3 is a cross-sectional view of a plasma reformer having electrodes in a vertical configuration in accordance with the present invention.

FIG. 4 is a perspective top view of a plasma reformer operated in accordance with the present invention.

FIG. 5 is a graph showing hydrogen yield and gas flow from a run of the plasma reformer plotted against time.

FIGS. 6A-C are cross sectional views of electrodes demonstrating partially and fully submerged configurations of the electrodes.

FIG. 7 shows a TEM image of a nanodispersed platinum-carbon catalyst made by this process with a nozzle injector.

### DETAILED DESCRIPTION OF PREFERRED EMBODIMENTS

The present invention includes methods and apparatus for reforming a feedstock using plasma reformation. Plasma reformation occurs by subjecting a feedstock to a plasma formed by an electric arc between two electrodes. In particular embodiments of the invention, a hydrocarbon feedstock is subjected to plasma reformation to produce a reformats product that is rich in hydrogen and a reformate product that includes carbon solids. Other feedstocks may also be subjected to plasma reformation such as, for example, oxygenated or oxidized compounds, e.g., compounds containing hydroxyls (alcohols), ether linkages, and ketones. The feedstocks can be gases or liquids.

A “plasma” is an ionized gas, and is usually considered to be a distinct phase of matter. A gas is “ionized” when at least one electron has been dissociated from a significant fraction of the molecules.

The solid product that is produced in the process is a carbon-containing solid. The carbon may be in various forms and may be mixed with other products or impurities. The carbon may be suitable for further beneficial processes or it may be treated as a waste by-product. Process conditions may be altered in order to increase the amount of carbon produced in a desirable form, such as carbon nanotubes and the like.

In a particular embodiment of the plasma reformer, a feedstock level is established in a plasma reformer reactor chamber. A pair of electrodes, which are separated by a gap therebetween, is arranged in the liquid feedstock so that at least a portion of the gap is submerged in the feedstock. If the electrodes are opposed axially, then the gap is typically formed between adjacent ends of the electrodes. If the electrodes are opposed laterally, i.e., at adjacent sides, then the gap is formed between the adjacent sides. The length or distance of the gap between the electrodes may typically be adjusted, either manually or automatically, by moving one or both of the electrodes. The gap may be axial, lateral, radial, or any other arrangement or combinations of arrangements that produce a gap that is identifiable by a spatial separation of a pair of electrodes having opposite polarity.

To begin operation, a voltage differential is applied across the electrodes to form an electrical arc in the gap. The electrical arc maintains contact with the feedstock to form the plasma in the reactor chamber. The reforming reactions are initiated within the plasma to produce, when the feedstock is a hydrocarbon, a solid carbon product and a gaseous reformate stream that is rich in hydrogen. The solid carbon product does not adhere to the electrodes but is suspended in the feedstock, accumulated at the bottom of the reactor chamber or combinations thereof.

In particular embodiments of the present invention, at least one electrode of the pair of electrodes can be adjusted in a direction that controls the gap length between the pair of electrodes. For electrodes that are opposed axially, the electrodes are typically adjusted axially to control the gap between adjacent ends of the electrodes. For electrodes that are opposed laterally, the electrodes are typically adjusted laterally to control the gap between adjacent sides of the electrodes. However, the electrodes may be adjusted in any direction, based upon their configuration and movement capability, to vary the length or distance of the gap between the pair of electrodes.

Controlling the gap length between the electrodes can provide control of the plasma size and the reformate production rate. During start-up of the plasma reformer, the electrodes are typically placed in very close proximity to one another by moving at least one of the electrodes in close proximity to the other electrode to reduce the required start-up voltage.

After a spark has formed in the gap and the plasma has been established, if the system is operated in a constant current mode, the electrodes may be separated to increase the gap length and thereby maintain a desired potential drop between the electrodes that corresponds to a desired hydrogen production rate. Alternatively, if the system is operated in a constant potential mode, the electrodes may be separated to increase the gap length (i.e., electrode spacing) and thereby maintain a desired potential between the electrodes that corresponds to a desired hydrogen production rate. As the potential increases above (or current decreases below) the desired value, the electrodes may be brought automatically into closer proximity with one another, thereby reducing the potential and reformate production. Similarly, as the potential decreases below (or current increases above) the desired value, the electrodes are automatically separated to increase the gap between the electrodes, thereby increasing the potential and reformate production.

Advantageously, by adjusting the gap length and thereby controlling the size and power of the plasma, the plasma reformer can be controlled to provide a specific flow rate of reformate nearly instantaneously. This allows the plasma reformer to provide reformate on-demand; i.e., reducing the gap length and power to produce less reformate during periods of less demand and increasing the gap length and power to produce more reformate during periods of high demand.

Another benefit of controlling the gap length or distance is that if carbon or another substance is deposited on the electrode or if part of the electrode breaks off due to erosion, corrosion or other cause, then the dynamic positioning of the electrodes to control the gap length ensures that the plasma is always maintained at a specific size and power. Such dynamic positioning increases the continuous operation time of the system and simplifies operation. For example, if the plasma momentarily collapses due to a piece of the electrode suddenly breaking off, then the system may automatically decrease the gap length by dynamically positioning the electrodes until the plasma is formed again and reformate production resumes.

In addition to the dynamic positioning of the electrodes relative to each other for gap control, the electrodes may also have the capability of being rotated along their axis or along another axis, usually parallel, to the axis of the electrode. One or both of the electrodes of the pair of electrodes may be rotated and rotation may be in either direction. When both electrodes are rotated, the electrodes may rotate in the same or different directions. Although not limiting the invention, the speed of rotation may range between about 10 and about 300 RPM or between about 30 and about 180 RPM.

Rotating at least one of the electrodes has been found to be useful, especially in a hydrogen production plasma reformer, to prevent or minimize carbon buildup on the electrodes. Carbon buildup can make the operation of the plasma reformer less efficient and cause loss of spark in the gap. During experimental operation of the plasma reformer of the present invention, it was observed that the carbon build-up on the electrodes did not occur on the face of the electrode where the electrons enter the arc, which is the electrode having negative polarity. While mere rotation of at least one of the electrodes greatly decreased the amount of carbon deposited on the electrode, it was found that by switching the polarity of the electrodes during operation, almost all the carbon deposition on the electrodes was halted. It was found that switching polarity at least once every ten minutes was sufficient to control the carbon deposition on the electrode. Higher frequency switching was used and there does not appear to be a limit on the maximum frequency that is effective.

Additionally, it was discovered that maintaining some degree of turbulence in the feedstock contained within the plasma reformer reactor chamber also reduces the amount of carbon deposited on the electrodes. Turbulence may be created by any method known to those having ordinary skill in the art including, for example, circulating the feedstock between the reactor chamber and a carbon recovery unit, such as a filter or centrifuge. Circulating the feedstock further prevents carbon buildup on the electrodes by carrying reformation carbon product away from the plasma while introducing fresh feedstock at the plasma surface.

The electrodes may be fabricated from many electrically conductive materials and the invention is not limited to any particular material or group of materials. Typical electrode materials include, for example, Pt, Pd, Au, Ir, Ru, W, C, Cu, Fe, Ti, Ag, Rh, Ni, Zr, Co, alloys of these materials and combinations thereof. Depending on the application, it may be advantageous to use a material that erodes or is otherwise consumed at a given rate for the production of supported catalysts, nanomaterials or other specialty material. These materials can include, for example, Pt, Pd, Au, Ir, Ru, Ag, Rh and combinations thereof but the invention is not limited to these materials. The electrode material may be plated onto a substrate, used in bulk solid form, installed as tips, or in any other way used as an electrical connection in the plasma reforming reaction chamber.

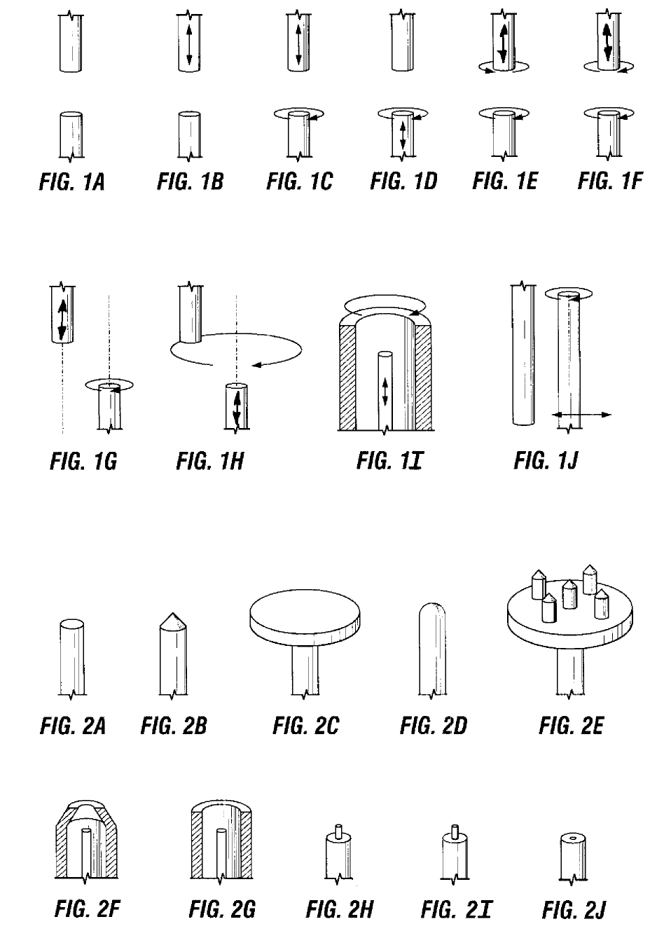

The electrodes may be arranged in a variety of configurations with varying movements, shapes and sizes as suitable for particular applications. FIGS. 1A-J are side views of pairs of electrodes arranged in a variety of exemplary arrangements and are capable of a variety of movements. FIG. 1A illustrates a pair of electrodes that are coaxially aligned with a set gap between the adjacent ends of the pairs of electrodes. FIG. 1B illustrates a pair of electrodes that are coaxially aligned with a set gap between the adjacent ends of the electrodes where one of the electrodes rotates about its axis. FIGS. 1C-F illustrate pairs of electrodes that are coaxially aligned and include at least one electrode of the pair that can be moved axially to adjust the gap length between the adjacent ends of the pairs of electrodes as well as having at least one electrode of the pair that rotates about its axis, with or without axial movement. FIGS. 1G-H illustrate pairs of axially opposed electrodes aligned along parallel axes. As shown, such electrodes may be stationary or have orbital rotations. Similar to the configurations disclosed above, these electrodes may also include at least one of the pair of electrodes as having axial or rotational movement capability. FIG. 1I illustrates a pair of electrodes that are coaxially aligned but in a concentric configuration. The relative motion of the inner and outer electrodes can be varied by applying to this configuration, for example, any of the exemplary rotation or linear positioning schemes described above. FIG. 1J illustrate a pair of electrodes that are opposed laterally, or radially since the electrodes are cylindrical, rather than opposed axially. The gap between this pair of electrodes is formed between the sides of the electrodes. Again, the relative motion of electrodes can be varied by applying to this configuration, for example, any of the exemplary rotation, revolution or linear positioning schemes described above. The present invention is not limited to the foregoing movements or combinations of movements, as other simple or complex movements would be expected to produce similar results. Furthermore, the various electrode movements may serve to move any given electrode gap to a different position or orientation within the chamber, such as moving from a fully submersed configuration to a partially submersed configuration or moving from a vertical configuration to a horizontal configuration.

It should be noted that while the exemplary configurations of electrodes illustrated in FIGS. 1A-J are all shown in a vertical arrangement, the electrodes may be configured horizontally or any other suitable configuration required for a given application.

The gap between the electrodes corresponds to the operating voltage and is limited only by the voltage supplied. Typical electrode gaps used to demonstrate this technology ranged from 0.1 mm up to 51 mm.

FIGS. 2A-J are perspective views of exemplary electrode tips suitable for use in a plasma reformer in accordance with the present invention. The tip configurations may be varied as shown in these exemplary tips to optimize various reforming parameters including, for example, electrode life, carbon product particle size distribution and/or efficiency. While the tips and electrodes illustrated in FIGS. 1-2 are cylindrical, the shapes of the electrodes are not so limited and any suitable electrode shape may be utilized in the practice of the present invention including, for example, triangles, rectangles, pentagons, hexagons and other polygons.

In some applications, especially if the electrodes are immersed in a gaseous fluid or are not fully immersed in a liquid fluid, it may be necessary to cool the electrodes. Adequate cooling of the electrodes may be provided in some applications by merely having the electrodes fully immersed in the liquid feedstock within the plasma reformer reactor chamber. Alternatively, if necessary, the electrodes may be cooled using a variety of other methods as known to one having ordinary skill in the art including, for example, providing the plasma reactor chamber with a cooling jacket to cool the feedstock level, circulating the feedstock from the reactor chamber through a cooler and/or circulating a cooling fluid, which may be the feedstock, through passages within the electrodes.

The feedstock suitable for use in the plasma reformer of the present invention includes liquids, gases and combinations thereof. In a particular embodiment of the present invention, hydrocarbons are subjected to plasma reforming to generate a gas stream rich in hydrogen content. Examples of hydrocarbons that are effective feedstocks for plasma reforming include commercial grade diesel, gasoline, JP-8, used motor oil, fresh motor oil, methane, ethane, acetylene, and vegetable oil. Suitable feedstocks also include C₅-C₄₀ alkanes, C₅-C₁₁ cycloalkanes and C₆-C₁₃ aromatic hydrocarbons.

Exemplary alkanes which may be reformed include, but are not limited to, n-pentane, n-hexane, n-heptane, n-octane, n-nonane, n-decane, and branched or substituted variants of these materials. Representative cycloalkanes include cyclopentane, methylcyclopentane, cyclohexane, methylcyclohexane, ethylcyclopentane, cycloheptane, and others. Finally, representative aromatic hydrocarbon materials include benzene, toluene, ethylbenzene, p-xylene, m-xylene, o-xylene, naphthalene, and a wide variety of other comparable materials.

In addition, light C₁-C₄ hydrocarbons are also desirable feedstocks. The feedstock may include aliphatic compounds, alcohols, aldehydes, pure compounds and/or mixtures of other compounds. Other feedstocks may include biodiesel, biomass oils/products, crude oil and kerosene. The examples of feedstocks suitable for plasma reforming provided above are not meant to limit the invention as other suitable feedstocks may be used and further, any of the feedstocks may be used alone or in combination with other feedstocks.

Other components may be added to the feedstock to increase the efficiency and/or yield of the plasma reformer or to modify the products for specific applications. For example, it may be desirable to include nanoparticles or particulate matter (e.g., metals, metal oxides, metal carbides, metal nitrides, metal borides, metal silicides, metal sulfides, and combinations thereof that comprise tin, bismuth, titanium, vanadium, chromium, manganese, iron, cobalt, nickel, copper, molybdenum, ruthenium, rhodium, palladium, silver, tungsten, rhenium, osmium, iridium, platinum, gold, and cerium.) for the formation of nanostructures, such as supported catalysts, single or multi-wall carbon nanotubes, buckyballs of various sizes, fullerenes or any other nanomaterial. These particles may be introduced into the chamber either in a liquid suspension, or a gaseous suspension. While the typical operation of the plasma reformer is anaerobic, the plasma reformer may also operate in the presence of oxygen-containing materials such as O₂, H₂O and/or air. Such materials may, if desired, be added to the plasma to control qualities of the final reformate product but are not required or, if the desired product is high purity hydrogen, typically desired.

The level of a liquid feedstock in the plasma reformer reactor chamber may be varied to affect the performance of the plasma reformer. The level may be adjusted so that the electrodes are fully submerged or partially submerged. Partially submerged electrodes are electrodes having a level of feedstock that allows the arc between the electrodes to contact the surface or the area just below the surface of the feedstock. Fully submerged electrodes are those that are fully or nearly fully covered by the feedstock. For particular embodiments of the present invention having a plasma reformer for producing hydrogen, it has been found that hydrogen production rates increase dramatically if the feedstock level is maintained approximately in the middle of the plasma, i.e., if the plasma is vertical, with the electrodes about equal distances above and below the surface, and if it is horizontal, with the center of the electrode face approximately at the surface.

Although not limiting the invention, the operating voltage across the electrodes may typically range, for example, about 1 V and about 50 kV, preferably between about 5 V and about 1000 V, more preferably between about 10 V and about 200 V, and most preferably between about 30 V and about 50 V. The voltage applied can be DC, AC, or high frequency AC, e.g., radio frequency (RF). Without limiting the invention, the current may typically range, for example, between about 5 mA and about 150 A, preferably between about 10 mA and about 120 A, and most preferably between about 20 A and about 100 A. Optionally, the power may be applied to the electrodes as a series of pulses of varying widths, i.e., with a duty cycle. This permits the system to be operated with higher efficiency. The appropriate selection of the most efficient voltage, current, and frequency parameters for a given application can be obtained experimentally, provided or estimated by one having ordinary skill in the art or a combination thereof.

Without limiting the invention, the pressure within the plasma reformation reaction chamber can typically vary, for example, between about 1 psia and about 1,000 psia or may be maintained between about 15 psia and about 100 psia when pressure generation is not a requirement of the system. However, when pressure generation is required, the plasma reformer can raise the pressure significantly through an increase in the number of moles of gas present in the system as, for example, when a hydrocarbon feedstock is reformed into hydrogen.

Without limiting the invention, the temperature of the feedstock within the plasma reformation reaction chamber may typically vary between cryogenic temperatures of about −200° C. and about 340° C. or more. In particular embodiments of the present invention, the temperature is preferably maintained between about −50° C. and about 140° C., more preferably between about 0° C. and about 120° C., and most preferably between about 25° C. and 100° C. Temperature constraints may be based upon limitations unrelated to the plasma generation or reforming reactions, such limitations being due, for example, to specific material selection of the reaction chamber and other “wet” portions of the system. While the efficiency of the plasma reforming process typically increases as temperature increases, the specific temperature required for a given application may vary depending upon the desired product.

The carbon produced while operating the plasma reformer with a hydrocarbon feedstock of the present invention may be characterized as ranging from fine, solid particulates to larger conglomerates of fine particles measuring about 2 to 5 cm in length. Carbon that was produced in a run was analyzed by Matrix Assisted Laser Desorption (MALDI) mass spectroscopy and showed that the fundamental carbon size was under 100 atoms (i.e., under 1,200 Daltons). The produced carbon also has been found to contain nanotubes, nanowires and fullerenes or buckyballs. To optimize the conditions for formation of such nanomaterials, suspended iron nanoparticles or soluble iron-containing compounds, e.g., ferrocene, may be added to the feedstock as an anchor for the growth of nanotubes.

The carbon particles may be separated from the feedstock using conventional gas/solid or liquid/solid (depending on the state of the feedstock) separation technologies. For example, the carbon may be separated from a liquid feedstock by running the liquid/solid stream through a centrifuge. A centrifuge operating at 3,000 RPM has been found to be suitable for separating the heavier carbon solids from the liquid hydrocarbon feedstock. The carbon conglomerates that settle into the plasma reformer reaction chamber may be removed from the chamber through a valve and then, if desired, ground into a fine powder that can be subsequently suspended in a hydrocarbon fuel that is suitable for use in any internal or external combustion engine, such as gas turbines, diesel engines, boilers, and in direct carbon fuel cells for energy recovery.

In particular embodiments of the invention, a cyclone separator was used to extract carbon particulate matter from the fuel stream. The main components of the system included a Krebs® Model P0.5-1960 Cyclone cast in 316 stainless steel coupled with a 1 HP motor and pump head capable of reaching approximately 5 GPM flow rate at 150 psi. Separations were performed for flows of 1.5 GPM and 5 GPM. At 5 GPM, the system requires the slurry to be pressurized to 134 psi and 74.2% of 5 micron and smaller carbon particulate will be recovered in a single pass. At 1.5 GPM, 12 psi of pressure is required and 54.6% of 5 micron and smaller carbon particulate will be recovered in a single pass.

In a particular embodiment of the invention, a flow-through centrifuge was used to extract carbon particulate matter from the fuel stream. The main components of the system included an AML Industries (Lavin) Model 12-413V Centrifuge having auto solid discharge capability, with a pump capable of providing from 0.5 to 12 GPM flow rate through the separation device. Separation simulations were run for flows of 0.5 GPM, 1.0 GPM, and 1.5 GPM. At 0.5 GPM, the carbon removal performance was optimal (>99% carbon removal by weight) with the effluent JP-8 visually clear, but not as clear as pure JP-8. These results were verified through the use of a flow-through centrifuge as a component in a hydrogen generator based on a plasma-based reformer.

In particular embodiments of the invention, an electrostatic precipitator was used to extract carbon particulate matter from both the gaseous fuel stream and the reformate gas stream. The main components of the system were a high voltage power supply and a capacitor-like carbon separator. The capacitor-like device consisted of a parallel plate set-up with a plate area of about 220 square centimeters and a plate separation of about 5 cm. The fine carbon particulate collected on the negatively charged plate. Gaseous flow rates through the device ranged from two standard liters per minute down to one-half liter per minute. For single-pass testing, the carbon removal ability varied with voltage applied to the “capacitor” and flow rate of gas through the device. In single-pass tests at 20,000 Volts and two liters per minute the parallel plate capacitor removed greater than 95% of the carbon by weight. Circular capacitors and other embodiments have also proven successful at carbon separation.

In particular embodiments of the present invention, it is preferred that the carbon particles be continuously removed from the plasma reformer reaction chamber. It was observed in the operation of a plasma reformer utilizing hydrocarbon feedstock to produce a hydrogen reformats stream that the plasma was not as bright, and therefore less hot, than a plasma formed in a reformer operated without removing the carbon. Circulating the feedstock from the reaction chamber back through the solid removal system, such as a cyclone, centrifuge, filter or combinations thereof, will provide removal of the carbon from the feedstock.

Utilization of the carbon produced by this system has been demonstrated both in a conventional internal combustion diesel engine as well as in a slightly modified gas turbine. These, as well as other energy converters may be used to utilize the energy contained in the carbon formed during the plasma reformation process. Some additional examples may include external combustion engines (steam turbines, thermoelectric devices, etc.), carbon fuel cells, or any other method of retrieving energy from carbon.

In addition to utilizing the carbon as a fuel, it may be utilized in its solid form to aid in carbon sequestration. This can include pressing into bricks, utilization in tires, or utilization in any other application where solid carbon may be desired. In addition, the carbon can be simply disposed of in a manner that insures it will remain in storage indefinitely as a means of preventing the release of CO or CO₂ into the environment.

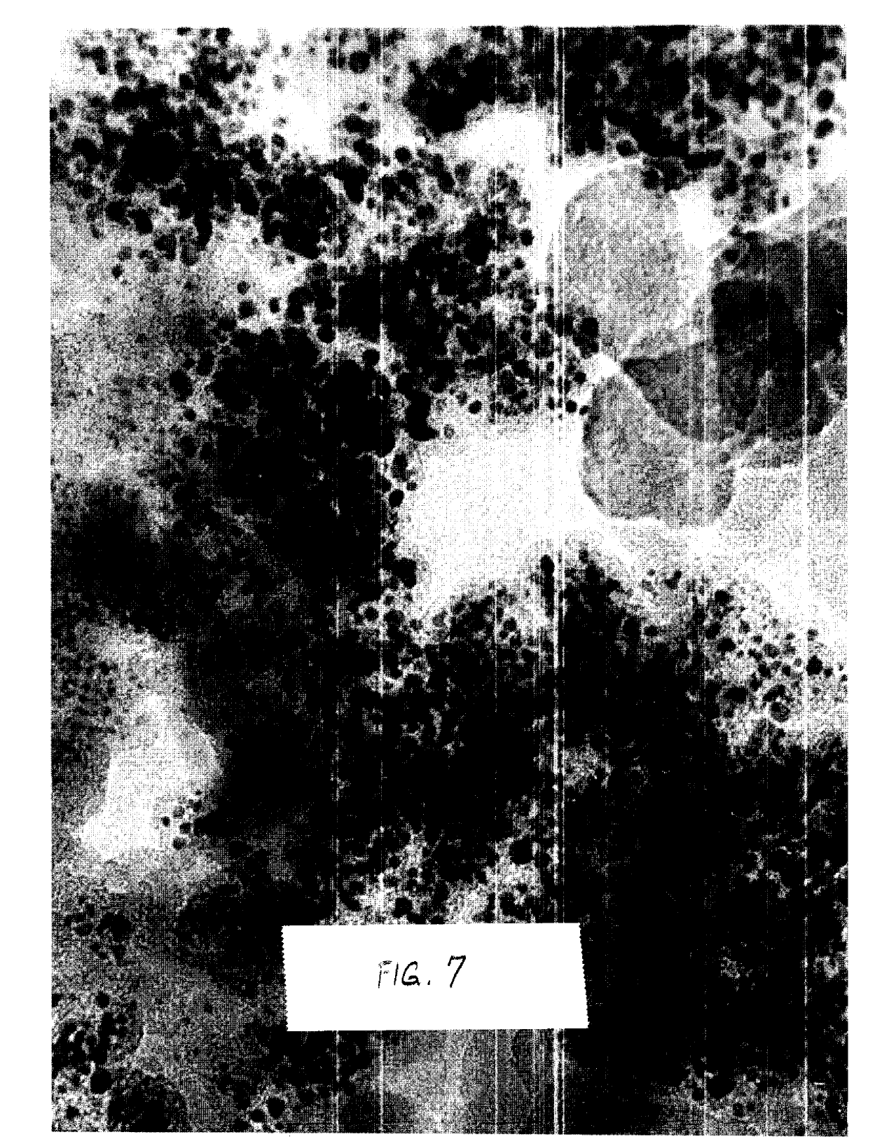

In yet another embodiment, different chemical compounds (e.g., metal-containing solutions, metal-containing organic or inorganic salts, organometallics, or combinations thereof) may be injected into the plasma to facilitate the production of specific products. If the chemical compounds contain a metal atom, desired metals would include, but are not limited to, tin, bismuth, titanium, vanadium, chromium, manganese, iron, cobalt, nickel, copper, molybdenum, ruthenium, rhodium, palladium, silver, tungsten, rhenium, osmium, iridium, platinum, gold, and cerium. For example, to create small carbon particles with high surface areas and an integrated catalyst, a platinum compound (i.e., platinum acetylacetonate (PtAcAc)) was dissolved in a hydrocarbon feedstock (such as styrene, AcAc, acetone, ethanol, methanol, etc.) and circulated through the plasma reformer or injected into the plasma volume via a nozzle. The concentration of the metal, in this case Pt, in the product is related to the concentration of the chemical compound or chemical compounds in the feedstock solution. In addition to forming Pt/C based catalysts, products have been produced by adding ferrocene in styrene as the hydrocarbon fluid. FIG. 7 shows a TEM (Transmission Electron Microscope) image of the nano-dispersed platinum-on-carbon catalyst made by this process with a nozzle injector using a solution of platinum acetylacetonate in liquid acetylacetonate comprising a total platinum to total carbon ratio of 0.05 by weight in the feedstock. The darker black spots are platinum and lighter gray patches are carbon as confirmed by EDS (Energy Dispersive Spectroscopy). The average platinum dot size is 4 nm.

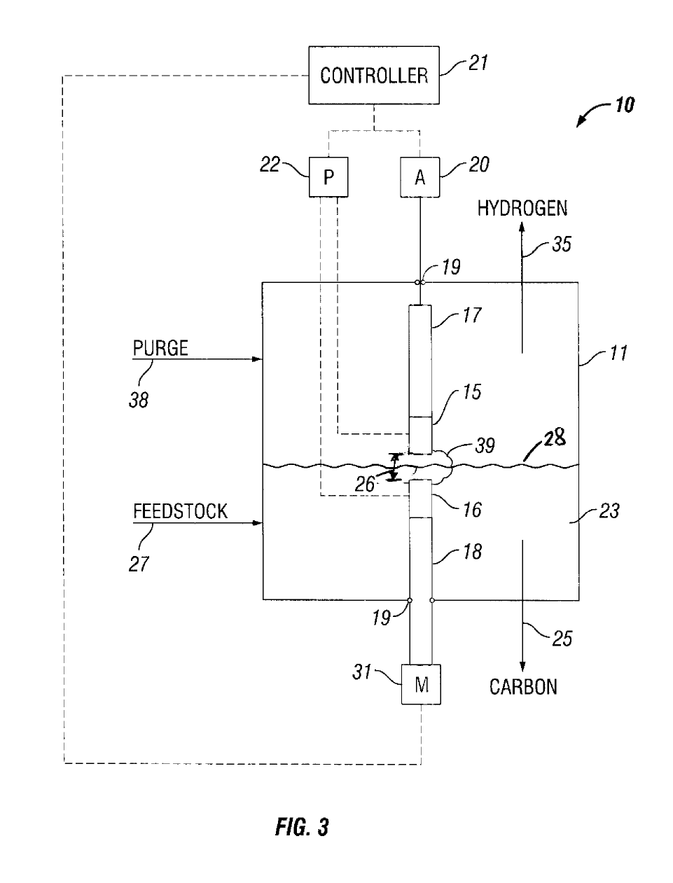

FIG. 3 is a cross sectional view of a plasma reformer having electrodes in a vertical configuration in accordance with the present invention. The plasma reformer 10 includes a reactor chamber 11 having a level 28 of liquid feedstock 23. A pair of electrodes 15, 16 is disposed within the reactor chamber 11 with a gap 26 therebetween. A source 27 of liquid feedstock is used to establish and maintain a level of feedstock 23 within the reactor chamber 11.

The lower electrode 16 is held by an electrode holder 18. The electrode holder 18 includes a shaft that is rotatably driven by a variable speed motor 31. The speed of rotation for the electrode 18 is controlled by a controller 21 that, for example, can control the speed of the variable speed motor 31. The controller 21 may be any controller known to those having ordinary skill in the art including, for example, one or more analog controllers and/or digital controllers including, for example, a computer or other processor based controller.

The upper electrode 15 is held by an electrode holder 17. The electrode holder 17 includes a shaft that is driven by a linear actuator 20. Both shafts of the electrode holders 17, 18 may be sealed with O-rings 19 or other seals, such as packing, for sealing a rotating and/or reciprocating shaft as known to those having ordinary skill in the art. The linear actuator 20 drives the upper electrode 15 in a linear motion to control the distance of the gap 26 between the electrodes 15, 16. The controller 21 receives current and/or voltage readings from the power supply 22 that generates a voltage differential between the electrodes 15, 16. The controller 21 adjusts the gap 26 length to control either the current, when the power supply 22 provides a constant voltage, or the voltage, when the power supply 22 provides a constant current. The power supply 22 may be manually set or receive control signals from the controller 21.

A purge gas 38 is injected into the reactor chamber to free the system of oxygen. A plasma 39 is generated by an electrical arc that forms in the gap 26 between the electrodes 15, 16. The reforming reactions that are initiated in the plasma generate hydrogen gas 35 and a solid carbon product 25.

### EXAMPLE 1

### Horizontal Electrode Configuration

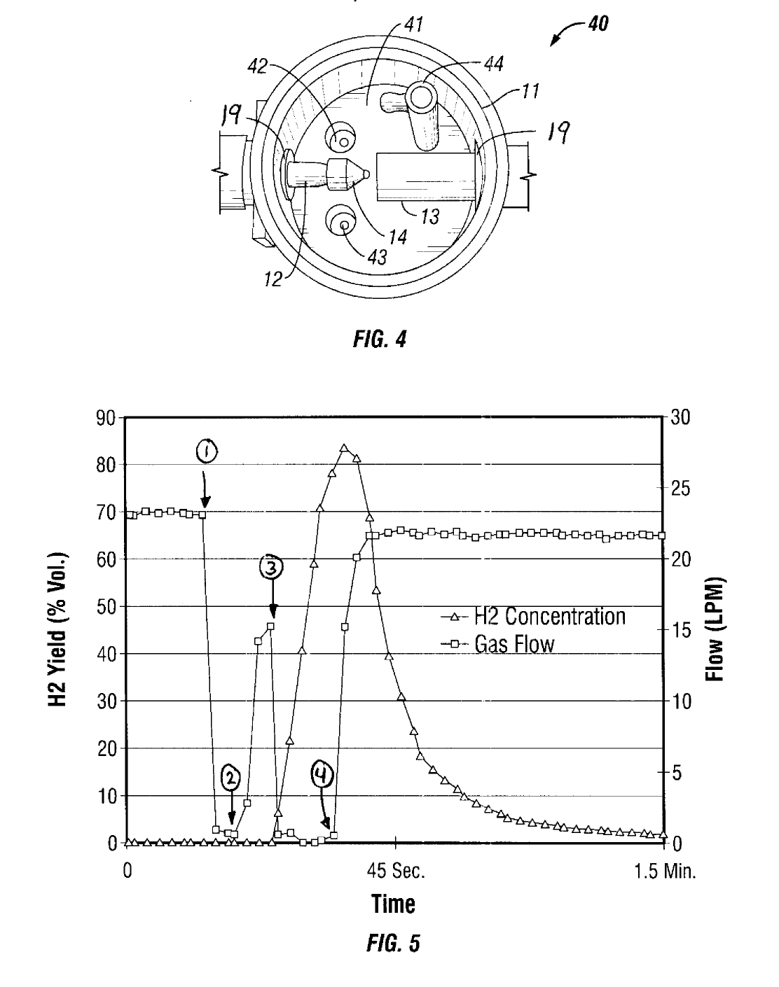

FIG. 4 is a perspective top view of a plasma reformer operated in accordance with the present invention. The plasma reformer 40 includes a reactor chamber 11 made from a 2″ diameter compression fitting to facilitate a gas-tight seal to the electrodes 12, 13 with Viton® O-rings 19. A spark plug 12 fitted with the tip 14 of a HyperTherm® electrode was chosen to be a non-resistor-type plug to avoid a high voltage drop due to the high operating current of the reformer. The tip 14 was brazed to the center electrode of the spark plug 12.

The counter electrode 13 was a ½″ diameter copper rod made from copper round stock. The positions of the electrodes were easily adjusted to set the gap between the electrodes because the electrodes were sealed with the O-rings, thereby.

The bottom of the reactor chamber 11 was capped with a 2″ plug 41. The plug 41 was fitted with a ⅛″ tube connection 42 to supply liquid hydrocarbon feedstock, i.e., diesel fuel, a ¼″ tube connection 43 for draining the remaining feedstock after operation, and a ¼″ tube connection 44 for purge gas introduction, such as nitrogen for purging the system, or hydrogen gas introduction for calibration of the analysis instrumentation.

The electrodes 12, 13 were then immersed in the liquid diesel fuel. No flow of an additional gas was used to operate the plasma reformer. Experiments showed vigorous hydrogen production at low plasma voltages of between about 10 and 50 V, which corresponds to between about 610 and 3,050 W of power while the plasma reformer was operated in a constant current mode at 61 A.

The plasma reformer 40 was operated in batch mode multiple times to estimate the power input that would be required to generate useful amounts of hydrogen. Only short plasma bursts were used because the diesel fuel in the chamber, about 50 mL, was not exchanged or circulated during each operation of the plasma reformer.

In a typical run, the plasma reformer reaction chamber was filled with diesel until the cone-shaped electrode tip was half-way covered in a partially submerged condition. The system was then purged with nitrogen at a flow rate of 10 LPM for about one minute to remove oxygen. Immediately after the purge cycle the plasma reformer was ignited. After about 15 seconds, the current was shut-off and nitrogen flow was resumed at 10 LPM to move the reformate product through a hydrogen sensor for analysis. The average input power to the plasma reformer was measured at 2.4 kW. Despite the short arc duration, a gas flow of 15 LPM containing over 83 vol % hydrogen was measured. This exceptionally high measured hydrogen concentration of 83 vol % was actually even higher because the dilution effect of the purge nitrogen in the 1.5 L reactor dead volume reduced the reading. These results correspond to a hydrogen production of about 5 L/min·kW.

After a separate run made to determine the carbon production, the diesel with the trapped carbon was removed from the plasma reformer reaction chamber and centrifuged. The recovered carbon was dried and weighed. The experiment yielded 0.273 g of carbon at a power input of 1,659 W. Assuming 12.5 wt % hydrogen content in the diesel fuel, it was calculated that 0.43 L of hydrogen was produced during the run. The H₂ flow during this run was calculated at 1.52 LPM.

FIG. 5 is a graph showing hydrogen yield and gas flow from a run of the plasma reformer plotted against time. The following points are marked as follows: 1) Stop flow of purge nitrogen; 2) Ignite the plasma reformer; 3) Shut off the current to the plasma reformer; and 4) Start flow of the nitrogen purge as a chase gas to push the hydrogen through the hydrogen analyzer. FIG. 5 illustrates that the horizontal electrode configuration, partially immersed in liquid diesel, showed a very fast start-up time of approximately 3 seconds to reach full hydrogen production.

### EXAMPLE 2

### Effect of Voltage and Current on Gas Production Rate

Varying the set-point for the voltage has a direct effect on both the absolute gas production rate as well as the specific production, which is a measurement of conversion efficiency. These experiments were all performed with a constant current power supply (either a Sorenson or a Miller welding power supply) with the voltage controlled by a microprocessor that drove a linear actuator to adjust the size of the gap by moving one of the electrodes. The electrodes in these examples were all made of high purity tungsten to reduce electrode erosion and were in the horizontal configuration. The electrodes were fully immersed in flowing JP-8 as the feedstock.

A series of tests were conducted to calculate at which voltage and current (amperage) combination the unit is most efficient in hydrogen production per unit power consumed. Each test represented a different voltage and amperage combination. The results, which are shown in Table 1, show that the combination of 30 Volts and 80 Amps provided reformate product at 2.34 mL/min·W and is one of the most efficient set point combination of those tested here.

TABLE 1
Effect of DC Voltage and Current on Reformate Gas Production

| Potential | Current | Power | Flow Rate | Production |
|---|---|---|---|---|
| (DC Volts) | (Amps) | (Watts) | (mL/min) | (mLH₂/min/Watt) |
| 25 | 40 | 1000 | 1392 | 1.39 |
| 30 | 40 | 1200 | 1936 | 1.61 |
| 25 | 60 | 1500 | 2188 | 1.46 |
| 30 | 60 | 1800 | 2653 | 1.47 |
| 33 | 60 | 1980 | 3763 | 1.90 |
| 40 | 60 | 2400 | 4372 | 1.82 |
| 50 | 60 | 3000 | 5283 | 1.76 |
| 25 | 80 | 2000 | 3261 | 1.63 |
| 30 | 80 | 2400 | 5616 | 2.34 |
| 33 | 80 | 2640 | 5397 | 2.04 |
| 40 | 80 | 3200 | 6359 | 1.99 |
| 50 | 80 | 4000 | 9144 | 2.29 |
| 25 | 100 | 2500 | 3914 | 1.57 |
| 30 | 100 | 3000 | 5280 | 1.76 |
| 40 | 100 | 4000 | 11505 | 2.88 |

Tests were also run using the plasma reformer operating with AC current to determine any effect on the production rate of the reformate gas. The results are shown in Table 2. The efficiency of the plasma reformer diminished significantly using AC current versus using DC.

TABLE 2
Effect of AC Voltage on Reformate Gas Production

| Potential | Current | Power | Flow Rate | Production |
|---|---|---|---|---|
| (Volts) | (Amps) | (Watts) | (mL/min) | (mLH₂/min/Watt) |
| 30* | 60* | 1800 | 1577 | 0.88 |
| 26.99 | 60* | 1619 | 1756 | 1.08 |
| 31.55 | 60* | 1893 | 1767 | 0.93 |
| 40* | 60* | 2400 | 1546 | 0.644 |

*Denotes control set points, not measurements. Both current and voltage are controlled in all cases, but the actual supplied voltage was not always measured thus the set point voltage was used in these instances.

### EXAMPLE 3

### Effect of Voltage and Current on Reformate Composition

Using the same configuration of a plasma reformer as described above in Example 2, a series of experiments was run to determine the effect that varying the voltage and current properties would have on the reformate gas composition. The results, which are shown in Table 3, demonstrate that the selection of the optimal voltage-current combination takes into effect both the gas production rate and the gas composition. These analyses showed light hydrocarbon content of the reformate gas to range between 12.6 and 6.2 percent by volume, while carbon monoxide and carbon dioxide content is under 0.25 percent by volume.

A minimum amount of oxides was expected since the process is pyrolitic. The small amount of oxygen that was present in this anaerobic process was due to oxygenated compounds in the fuel itself and to any oxygen that is naturally present in the fuel as dissolved oxygen, dissolved water or other oxygenated compounds.

TABLE 3
Effect of DC Voltage and Current on Reformate Gas Composition

| | 25 VDC | 25 VDC | 25 VDC | 35 VDC | 35 VDC | 35 VDC |
|---|---|---|---|---|---|---|
| | 50 Amp | 75 Amp | 100 Amp | 50 Amp | 75 Amp | 100 Amp |
| CH₄ (ppm) | 12000 | 40000 | 41000 | 28000 | 51000 | 47000 |
| C₂H₄ (ppm) | 4300 | 23000 | 32000 | 17000 | 35000 | 38000 |
| C₂H₂ (ppm) | 7200 | 22000 | 23000 | 18000 | 25000 | 32000 |
| CO (ppm) | 370 | 1400 | 1200 | 1700 | 1200 | 1500 |
| CO₂ (ppm) | 110 | 1100 | 150 | 120 | 81 | 80 |
| H₂S (ppm) | <100 | <100 | <100 | <100 | <100 | <100 |
| H₂O (%) | 0.68 | 0.59 | 0.36 | 0.51 | 0.47 | 0.29 |
| Flow (SLPM) | 300 | 2000 | 4000 | 875 | 4200 | 8000 |
| H₂ (%) | 96.9 | 90.7 | 89.9 | 93.0 | 88.3 | 87.9 |

### EXAMPLE 4

### Effect of Feedstock Level in Reactor Chamber and Electrode Materials

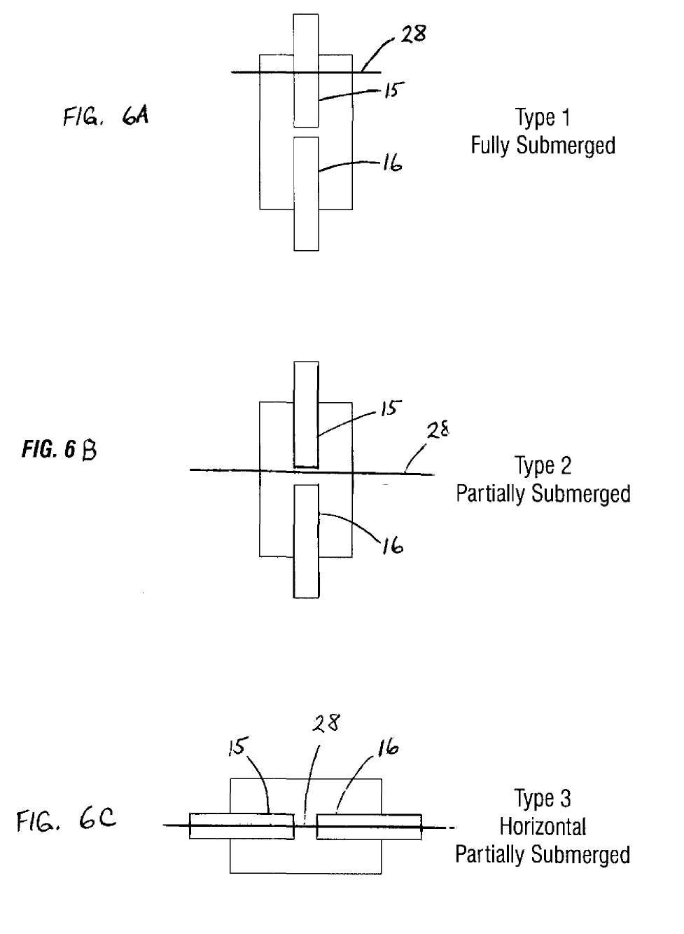

A reformate plasma reformer was operated according to the present invention using carbon electrodes and using tungsten electrodes to determine if there was an effect on the reformate gas production based upon the materials used for the electrodes. The feedstock level was also varied to determine the effect on reformate gas production by the feedstock level in the plasma reformer reaction chamber. As illustrated in FIGS. 6A-C, the feedstock levels that were tested included fully submerged vertical electrodes (Type 1), partially submerged vertical electrodes (Type 2) and partially submerged horizontal electrodes (Type 3). The results of the experiments are shown in Table 4.

In each of the examples, one electrode was rotated at 30 RPM while the set voltage was maintained by automatically controlling the gap size and using a power supply operating in constant current mode. As may be seen by the results in Table 4, there appears to be no significant effect on the reformate gas production when using electrodes of different materials. However, it may be desirable to select electrode materials based upon possible contamination, catalytic effects, longevity, or other material properties.

There was a significant difference between operating the plasma reformer with a fully submerged set of electrodes and with a partially submerged set of electrodes. The plasma reformer generated significantly higher gas production with the electrodes only partially submerged.

TABLE 4
Effect of Feedstock Level and Electrode Materials on Reformate Gas Production

| | | | Reformate Gas Production (mL/min) | | | | | |
|---|---|---|---|---|---|---|---|---|
| | | | | | Partially Submerged | | Partially Submerged | |
| Plasma Generation | | | Fully Submerged | | (Vertical) | | (Horizontal) | |
| Potential | Current | Power | Type 1^{a} | Type 1^{a} | Type 2^{a} | Type 2^{a} | Type 3^{a} | Type 3^{a} |
| (DC Volts) | (Amps) | (Watts) | Tungsten | Carbon | Tungsten | Carbon | Tungsten | Carbon |
| 25 | 50 | 1250 | 300 | | 800 | | 1020 | |
| 20 | 65 | 1300 | | | | | | 2000 |
| 20 | 70 | 1400 | | | | | | 2000 |
| 25 | 65 | 1625 | | | | | | 2000 |
| 35 | 50 | 1750 | 875 | | 750 | | 962 | |
| | | | | | 875 | | | |
| 25 | 75 | 1875 | 2000 | 3750 | 5000 | 4800 | 2500 | 2400 |
| | | | | | | 4800 | | |
| 35 | 60 | 2100 | | | | | | 2500 |
| 35 | 60 | 2100 | | | | | | >2500 |
| 25 | 100 | 2500 | 4000 | 5400 | 4200 | 6700 | 4250 | 5500 |
| | | | | | 4375 | | 6000 | |
| | | | | | 6000 | | | |
| 35 | 75 | 2625 | 4200 | | 1500 | | 3000 | 3500* |
| | | | | | 2250 | | 3250 | |
| | | | | | 4125* | | | |
| | | | | | 9200 | | | |
| 30 | 100 | 3000 | | 8000 | | 6750 | | |
| 32.5 | 100 | 3250 | 4000 | 6100 | 7000 | 6000 | 9000 | 6000 |
| 35 | 100 | 3500 | 8000 | 7000* | 2500 | 6000* | 7500* | 4773 |
| | | | | | 3500* | | 7500* | |

*Indicates unstable plasma and the voltage applied exceeded the Sorensen OVP (44 Volts). Flow rates were recorded in mL/minute
^{a}See FIG. 6.

### EXAMPLE 5

### Carbon Production

A series of tests was performed to determine the amount of carbon chunks and carbon paste produced at different combinations of voltage and amperage. The plasma reformer was operated, utilizing JP-8 as a fuel as described above, for a period of three hours for each test. Each test represented a different voltage and amperage combination including 25 and 30 Volts and 40, 60, and 80 Amps. At the conclusion of each test the carbon paste and chunks were collected from the centrifuge and plasma reformer chamber, respectively. The samples were then weighed separately to determine which combination resulted in more or less carbon paste and carbon chunks. This information is vital in choosing the best method of transforming carbon to electricity.

The results of the experiments suggested that at higher currents more of the carbon was in the form of solid chunks. Based on these results, for further testing the set point potential was established at 30 Volts with the set point current at 80 Amps, and the electrodes were set to rotate at two to three revolutions per minute. On average, the reformer system produced 37.48 grams of large carbon particulates per hour and the centrifuge basket collected 63.01 grams of carbon paste per hour during the continuous six to seven hours of run time per day.

Differing qualities of power supplies also affect the type and rate of carbon formation. For instance, high quality, well regulated laboratory power supplies produced large carbon chunks while power supplies with less precision produced smaller carbon chunks. The Sorensen DLM40-100 power supply has better voltage and current regulation capabilities and the ability to maintain constant current and voltage during fuel reformation, as compared to the Miller Maxstar® 150S. The drawback of the Sorensen having a more constant voltage output is that the carbon growth on the tungsten electrode tip tends to be greater and to grow longer at a constant rate until both of the electrodes short electrically and then the carbon falls off of the electrode tip. With the Miller Maxstar® 150S, the actual voltage fluctuated around the set point voltage (±5 volts), which caused the carbon to fall from the tip at shorter carbon lengths. The large carbon particles made by the Miller Maxstar® 150S were much shorter in length than those of the Sorensen DLM40-100. The large carbon particles produced using the Miller Maxstar® 150S were dime to quarter-sized carbon chunks (<6 mm length) while the large carbon particles produced using the Sorensen DLM40-100 power supply were long dime to quarter sized carbon chunks (13 mm to 51 mm length).

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. For example, the phrase “a solution comprising a phosphorus-containing compound” should be read to describe a solution having one or more phosphorus-containing compound. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention.

It should be understood from the foregoing description that various modifications and changes may be made in the preferred embodiments of the present invention without departing from its true spirit. The foregoing description is provided for the purpose of illustration only and should not be construed in a limiting sense. Only the language of the following claims should limit the scope of this invention.

What is claimed is:

1. A method for producing hydrogen gas, comprising:
supplying a hydrocarbon fluid to a pair of spatially separated electrodes defining a gap between the pair of electrodes;
applying a voltage across the pair of electrodes to induce an electrical arc in the gap, wherein the electrical arc contacts the hydrocarbon to form a plasma and produce a gaseous product comprising hydrogen gas and a solid product comprising carbon; and
dynamically adjusting the spatial separation of the electrodes to change the length of the gap so as to control at least one parameter of the plasma.

2. The method of claim 1, further comprising:
decreasing the gap length during initiation or reformation of the plasma.

3. The method of claim 1, further comprising:
increasing the gap length to increase the rate of hydrogen gas production.

4. The method of claim 1, further comprising:
maintaining a constant electrical current flow between the pair of electrodes; and
increasing the gap length to increase the voltage between the pair of electrodes, resulting in an increase of the plasma size and an increase of the hydrogen gas production rate.

5. The method of claim 1, further comprising:
maintaining a constant electrical current flow between the pair of electrodes; and
decreasing the gap length to decrease the voltage between the pair of electrodes, resulting in a decrease of the plasma size and a decrease of the hydrogen gas production rate.

6. The method of claim 1, further comprising:
rotating at least one of the electrodes during the step of generating hydrogen gas.

7. The method of claim 6, wherein the rotation of the at least one of the electrodes reduces adherence of the solid product to the pair of electrodes.

8. The method of claim 6, wherein rotation of the at least one of the electrodes does not change the gap length.

9. The method of claim 1, further comprising:
rotating at least the negative polarity electrode during the step of generating hydrogen gas.

10. The method of claim 1, further comprising:
periodically reversing the polarity of the electrodes.

11. The method of claim 10, wherein the periodic reversing of the electrode polarity reduces adherence of the solid product to the pair of electrodes.

12. The method of claim 1, wherein the gap length is dynamically adjustable between about 0.1 mm and about 51 mm.

13. The method of claim 1, wherein the hydrocarbon fluid is a liquid.

14. The method of claim 13, further comprising:
controlling the level of the hydrocarbon liquid relative to the pair of electrodes.

15. The method of claim 13, wherein the pair of electrodes is generally horizontally spaced, and the hydrocarbon liquid level only partially submerges each of the electrodes.

16. The method of claim 13, wherein the pair of electrodes are generally vertically spaced, and the hydrocarbon liquid level submerges one electrode and does not submerge another electrode.

17. The method of claim 13, wherein both electrodes are fully immersed in the hydrocarbon.

18. The method of claim 13, wherein only one electrode is fully immersed in the hydrocarbon.

19. The method of claim 13, wherein neither electrode is fully immersed in the hydrocarbon.

20. The method of claim 13, wherein at least one of the electrodes is fully above the level of the hydrocarbon liquid.

21. The method of claim 13, wherein the hydrocarbon liquid comprises at least two hydrocarbon feedstocks.

22. The method of claim 1, further comprising:
adding a chemical compound into the hydrocarbon fluid to increase production of a desired solid product.

23. The method of claim 22, wherein the chemical compound comprises at least one metal atom.

24. The method of claim 23, wherein the at least one metal atom is selected from the group consisting of tin, bismuth, titanium, vanadium, chromium, manganese, iron, cobalt, nickel, copper, molybdenum, ruthenium, rhodium, palladium, silver, tungsten, rhenium, osmium, iridium, platinum, gold, and cerium.

25. The method of claim 22, wherein the metal compound comprises at least two chemical compounds.

26. The method of claim 1, wherein the voltage differential across the electrodes ranges between about 1 V and about 50 kV.

27. The method of claim 1, wherein the voltage differential across the electrodes ranges between about 30 V and about 50 V.

28. The method of claim 1, wherein a current flow between the electrodes ranges between about 5 mA to about 150 A.

29. The method of claim 13, further comprising:
providing an essentially anaerobic atmosphere over the hydrocarbon fluid.

30. The method of claim 1, further comprising:
removing dissolved or entrained oxygen from the hydrocarbon fluid prior to supplying the hydrocarbon fluid into the gap.

31. The method of claim 1, further comprising:
circulating the liquid hydrocarbon through a solids separation device; and
separating at least a portion of the solid carbon product suspended in the circulating liquid hydrocarbon.

32. The method of claim 13, further comprising:
controlling the flow of hydrogen gas out of a chamber surrounding the pair of electrodes to obtain a desired pressure within the chamber.

33. The method of claim 1, further comprising:
circulating the hydrocarbon fluid supplied to the pair of electrodes.

34. The method of claim 1, wherein the hydrocarbon fluid is a gas.

35. The method of claim 34, further comprising:
separating out the solid carbon from the hydrogen gas by electrostatic precipitation.

36. The method of claim 22, wherein the chemical compound is an organometallic compound.

37. The method of claim 36, wherein the organometallic compound is a metal-containing organic or inorganic salt.

38. The method of claim 37, wherein the metal-containing compound is a platinum compound.

39. The method of claim 37, wherein the organometallic compound comprises platinum.

40. The method of claim 13, wherein the gaseous product produced comprises hydrogen gas at greater than 70 volume percent hydrogen.

41. The method of claim 13, wherein the gaseous product produced comprises hydrogen gas at greater than 80 volume percent hydrogen.

42. The method of claim 13, wherein the gaseous product produced comprises hydrogen gas at greater than 90 volume percent hydrogen.

43. The method of claim 13, wherein the gaseous product produced comprises hydrogen gas at greater than 95 volume percent hydrogen.
